(19) United States
(12) Patent Application Publication
(10) Pub. No.: US 2010/0019754 A1
(43) Pub. Date: Jan. 28, 2010

(54) Power Converter for Solar Electrical Current Installations and Method for Controlling it

(75) Inventor: Dejan SCHREIBER, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: SEMIKRON Elektronik GmbH & Co. KG, Nurnberg (DE)

(21) Appl. No.: 12/509,284

(22) Filed: Jul. 24, 2009

(30) Foreign Application Priority Data
Jul. 26, 2008 (DE) 10 2008 034 955.0

(51) Int. Cl. G05F 3/08

(52) U.S. Cl. 323/311

(57) ABSTRACT

A power converter having a d.c. voltage input which varies over time and has a maximum voltage, a level converter and at least one inverter, which can be connected to an electrical network. The positive input of the d.c. voltage input is connected with a first switch and with the anode of a first diode. The negative input of the d.c. voltage input is connected with a second switch and with the cathode of a second diode. The cathode of the first diode is connected with a first capacitor, the anode of the second diode with a second capacitor. The two switches and the two capacitors are connected, and their center taps are likewise connected. This constitutes the level converter, which is connected with a downstream inverter. The two capacitors are thereby charged, independently of the input voltage, each at half the value of the set-point intermediate circuit voltage.

### BACKGROUND OF THE INVENTION

1. Field of the Invention

The invention relates to a power converter having a d.c voltage input, whose voltage value varies over time such as is supplied by a solar cell and having a d.c. voltage output, and a method for controlling such a power converter. Such a power converter arrangement is basically suited for any application with an input d.c. voltage which varies over time.

2. Description of the Related Art

Solar cells in which individual panels are arranged in a two-dimensional matrix are known. In such solar cells, the individual panels of individual columns and rows of this matrix are serially connected with each other, and therefore constitute a solar panel chain. It is furthermore known to connect such solar panel chains in parallel, and, in the process, to connect the output poles of this connection with an electrical network by means of an inverter-feed electrical current to the connected electrical network. A solar electrical current installation of this type is relatively inexpensive to manufacture.

One disadvantage of known solar panels is that their output voltage, as well as their power output, greatly vary as a result of the effective light intensity. In the above-mentioned solar electrical current installation, it is particularly disadvantageous that switching off an individual panel leads to a greatly overproportional reduction of the power output of a solar panel chain. Thus, the actual degree of efficiency of such a solar power installation is far less than the theoretical maximum degree of efficiency at a given light intensity.

It is also known to connect an individual solar panel chain directly to an assigned inverter and to connect the a.c. voltage outputs of individual inverters with the electrical network to be supplied with power. In this case, the costs in regard to circuit technology, and the number of electronic power components for this embodiment, are considerably greater than in the first mentioned embodiment. However, advantageously these costs do permit a greater actual degree of effectiveness.

A solar electrical current installation with one inverter per individual panel would achieve an optimal degree of effectiveness along with the greatest costs at the same time. However, this design makes less economic sense due to the increased costs.

### SUMMARY OF THE INVENTION

It is an object of the invention to provide a power converter which may be used in a solar cell installation and which has an improved ratio of the actual degree of efficiency and costs in regard to circuit technology.

The invention is directed to solar electrical current installations, each of which has a d.c. voltage output that varies with time, and which are serially connected and therefore have a summed d.c. voltage output that varies over time. This summed d.c. voltage output having a defined maximum value constitutes the d.c. voltage input of a power converter in accordance with the invention.

The inventive power converter has at least one level converter and at least one inverter, which can be connected with an electrical current network. The positive input pole of the d.c. voltage input is connected with a first switch and with the anode of a first diode. The negative input pole of the d.c. voltage input is connected with a second switch and with the cathode of a second diode. The cathode of the first diode is connected with a first side of a first capacitor; the anode of the second diode is connected with a first side of a second capacitor. Also, the two switches are connected to each other and the two capacitors are connected to each other, and the center taps of the switches and the capacitors are connected with each other, and preferably also with ground. This arrangement constitutes the level converter.

It may be furthermore preferred to connect a first inverter with the first capacitor and a second inverter with the second capacitor, so that the first input of the first inverter is connected with the first output of the level converter, and the second input of the first inverter connected with the center tap of the switches, and the center tap of the capacitors. Therefore the first input of the second inverter is connected with the center tap of the switches, and the center tap of the capacitors, and its second input is connected with the second output of the level converter. Similarly, it may be preferred to connect the inputs of an inverter with the two outputs of the level converter.

It may furthermore be preferred to connect at least one input pole of the d.c. voltage input with a coil. It is alternatively possible for the parasitic inductance of the connectable d.c. voltage feed line to take up the function of the coil in accordance with the inventive method.

The method in accordance with the invention for controlling the said power converter arrangement has two operational states. As long as a voltage, which is equal to or higher than the set-point intermediate circuit voltage, is applied to the d.c. voltage input, the level converter is not controlled. If a voltage is applied to the d.c. voltage input which is less than the set-point intermediate circuit voltage, the level converter is controlled so that a modulation factor of 1 results and by means of this the first and second capacitors are charged with respectively half the value of the set-point intermediate circuit voltage (V_{dcS}). The modulation factor is the weighted ratio of the values of the d.c. voltage, or more precisely, the phase voltage at the output, and of the intermediate circuit voltage. In connection with this, three more partial operational states exist:
At an input d.c. voltage of less than half the value of the set-point intermediate circuit voltage V_{dCS}, the first and second switches of the level converter are controlled so that the activation times of the two switches overlap, i.e., at least one switch is always switched on, and the activation times alternate.
At an input d.c. voltage equal to one half the value of the set-point intermediate circuit voltage V_{dcS}, the first and second switches of the level converter are controlled in such a way that the activation times of the two switches are each half a switching period long, while the activation times again alternate.
At an input d.c. voltage of greater than half the value of the set-point intermediate circuit voltage V_{dcS}, the first and second switches of the level converter are controlled so that the activation times of the two switches are less than half a switching period, i.e., there are times at which no switch is switched on, while the activation times alternate.

In the second operational state, the at least one inverter connected downstream of the level converter always operates independently of the input d.c. voltage at every operational time at an approximately constant intermediate circuit voltage of the set-point intermediate circuit voltage, which here is the sum of the two capacitor voltages. In this way, it is assured that the modulation factor is approximately 1, and the inverter operates with an optimum degree of efficiency.

The inventive method offers the advantage that a solar cell provided with this power converter arrangement has an improved ratio of the actual degree of efficiency and the technical switching outlay.

The invention further permits reaction to voltage fluctuations in the electrical network in such a way that they are measured, the set-point intermediate circuit voltage is adapted, based on the voltage fluctuations, and from this the control of the level converter is changed so that, within narrow limits, a modulation factor of approximately 1 can be achieved.

Particularly preferred further embodiments of the inventive power converter and its control methods are mentioned in the respective description of the exemplary embodiments. Moreover, the attainment of the objects in accordance with the invention will be further explained by means of the exemplary embodiments described below.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows an inventive power converter according to a first embodiment of the invention;

FIG. 2 shows an inventive power converter according to a second embodiment of the invention; and

FIG. 3 shows different voltage progressions in the course of the application of the inventive method.

### DETAILED DESCRIPTION OF THE PRESENTLY PREFERRED EMBODIMENTS

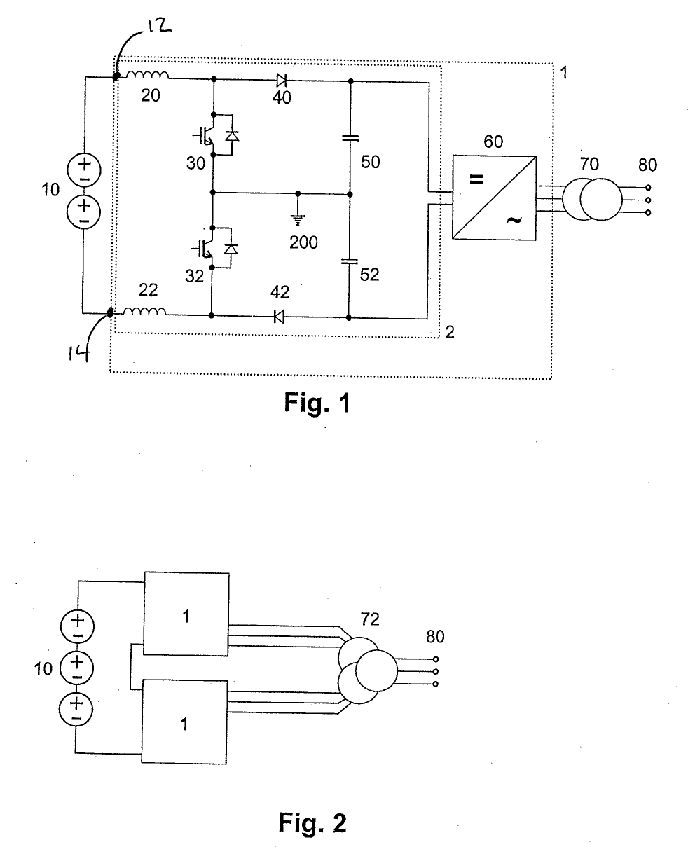

FIG. 1 shows a power converter 1 in accordance with the invention in a first embodiment of a solar cell. As a voltage source 10, this solar electrical current installation has a solar cell arrangement designed as an arrangement of solar panel chains, which are connected with each other in such a way that this solar cell arrangement provides a time-varying output voltage between 0V and 1200V, or between 300V and 1200V.

A level converter 2 of power converter arrangement 1 has a d.c. voltage input. The positive input pole 12 of this d.c. voltage input is connected with a first switch 30 and with the anode of a first diode 40 preferably through a coil 20. Furthermore, the negative input pole 14 of the d.c. voltage input is connected with a second switch 32 and with the cathode of a second diode 42, preferably through a coil 22. The cathode of first diode 40 is connected with a first capacitor 50. The anode of second diode 42 is connected with a second capacitor 52. Also, switches 30, 32, are connected to each other as are capacitors 50, 52. Their center taps are connected with each other and with ground. First and second switches 30, 32 are known semiconductor power elements, for example IGBTs, each with anti-parallel switched recovery diodes.

A three-phase inverter, constructed from semiconductor power elements of the voltage class 1200V, is provided as an inverter 60 of power converter 1. Inverter 60 has an output to a transformer 70 of an input voltage of 3×400V, by means of which it supplies an electrical network 80. Inverter 60 shows a high degree of efficiency of up to 99%, provided that the intermediate circuit voltage fluctuates around the required value of 650V by no more than 10%.

In contrast thereto, the input voltage, as well as the input current, of power converter 1 can fluctuate within the above mentioned range rapidly as a result, for example of shadows passing over the solar cell, and slowly as a result of differences in the strength of sunlight during the day. The method in accordance with the invention for controlling this power converter arrangement 1 takes this into consideration in that capacitors 50, 52 are charged in such a way that, during those operational periods in which the input voltage of the inverter 60 lies below the set-point intermediate circuit voltage (V_{dcS}), the sum of their charges corresponds to the set-point intermediate circuit voltage V_{dcS}.

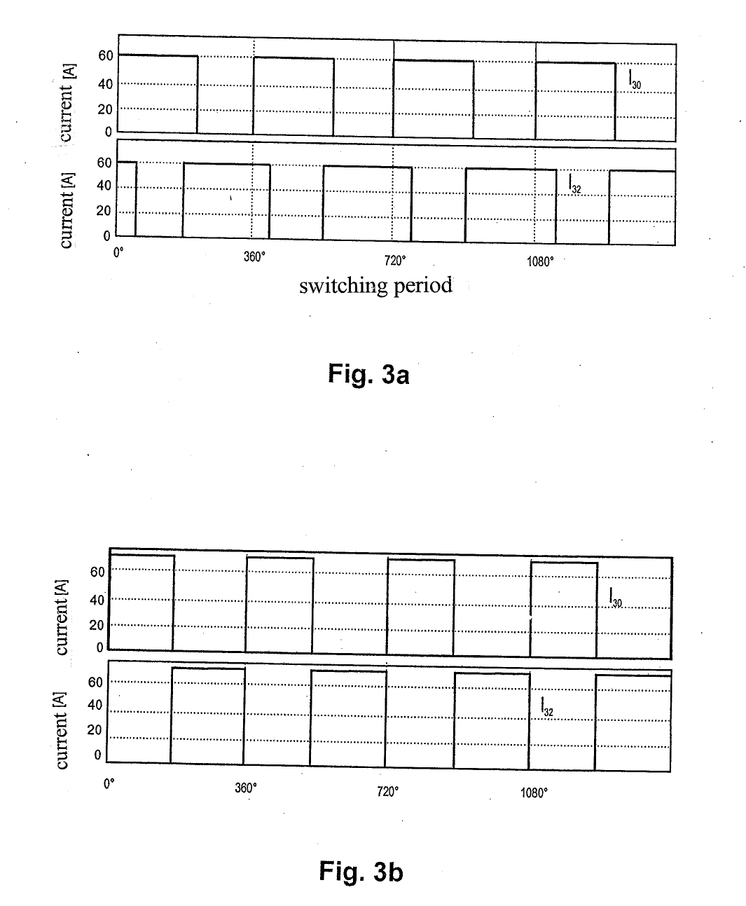

FIG. 2 shows power converter arrangement 1 in accordance with the invention in a second embodiment of a solar cell. Here, instead of the embodiment described in FIG. 1, two inverters 60 are serially connected with the solar cell 10 and together feed a transformer 72 for supplying electrical network 80. Here, with the identical embodiment of power converter 1 shown in FIG. 1, the outlet voltage of the solar cell can have twice the maximum voltage value.

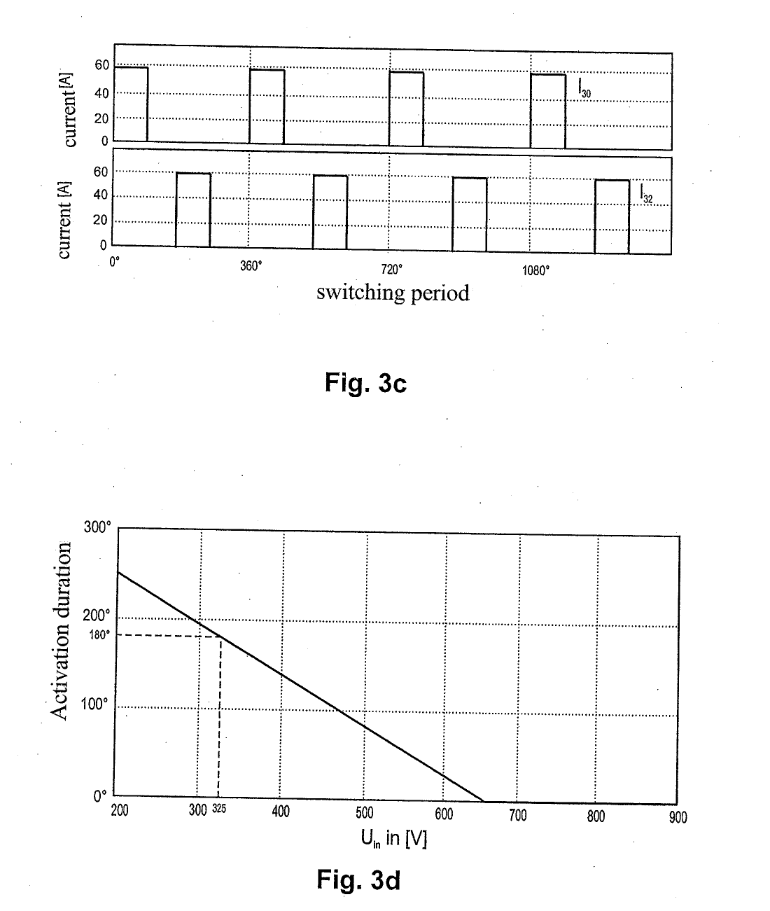

FIG. 3 shows different voltage progressions in the course of the application of the method in accordance with the invention for controlling level converter 2, with the provision that a voltage is present at the d.c. output which is less than the set-point intermediate circuit voltage V_{dcS}. The respective course of the currents I₃₀ and I₃₂ through the first and second switches is represented, i.e., the switching states of the first and second switches. The numerical values relate to the above mentioned example with an intermediate circuit voltage of 650V, which result from a target value of 1 for the modulation factor and an output a.c. voltage of 3×400V.

FIG. 3a is based on the representation on an input voltage Uᵢₙ of 250V. In accordance with the method of the invention, from this a set-point value of the capacitor voltages of 325V each results at a set-point intermediate circuit voltage V_{dcS} of 650V. This is achieved in that the duration of activation is 220° per switch. A continuously activated switch would have an activation duration of 360°. Furthermore, the two switches are offset by 180° in respect to each other, i.e. alternatingly activated. It can be seen that the respective activation durations of the two switches overlap.

In FIG. 3b, the representation is based on an input voltage Uᵢₙ of 325V. In accordance with the inventive method of the invention, a set-point value of the capacitor voltages of 325V each results at a set-point intermediate circuit voltage V_{dcS} of 650V. This is achieved in that the activation duration comes to 180° per switch. Furthermore, the two switches are offset by 180° in respect to each other, i.e. alternatingly activated, so that one and only one of the two switches is always turned on.

In FIG. 3c, the representation is based on an input voltage Uᵢₙ of 500V. In accordance with the method of the invention, a set-point value of the capacitor voltages of 325V each results at a set-point intermediate circuit voltage V_{dcS} of 650V. This is achieved in that the activation duration comes to 80° per switch. Furthermore, the two switches are offset by 180° in respect to each other, i.e., alternatingly activated, so that there are phases in which neither of the two switches is turned on.

In a diagram, FIG. 3d shows the interconnection between the activation time of one of the two switches and the input voltage Uᵢₙ. It can be seen that by means of the inventive method, all voltage values of the input voltage Uᵢₙ between 200V and 650V lead to a set-point intermediate circuit voltage V_{dcS}. At values of the input voltage Uᵢₙ above 650V, both switches are permanently turned off, because of which the intermediate circuit voltage also rises above 650V and an operation of the inverter at a modulation factor of 1 is no longer possible. Therefore, the solar cell should be dimensioned in such a way that its no-load voltage, i.e. the maximum input voltage of the power converter arrangement, has a value of 110% of the set-point intermediate circuit voltage V_{dcS} at low outside temperatures.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power converter, having a d.c. voltage input which varies over time, has positive and negative inputs, and has a maximum voltage, the converter being capable of being connected to an electrical network having an inverter, the converter comprising:
a positive input pole for receiving a positive input from the d.c. voltage input and a negative input pole for receiving a negative input from the d.c. voltage input;
a first switch connected to said positive input pole of the d.c. voltage input at a first side of said first switch;
a first diode having an anode connected to said positive input pole and to said first side of said first switch;
a second switch connected to said negative input pole of the d.c. voltage input at a first side of said second switch, and having a second side connected to a second end of said first switch at a first center tap;
a second diode having a cathode connected to said negative input pole and to said first side of said second switch;
a first capacitor having a first side connected to the cathode of said first diode and a second side, opposite to said first side thereof; and
a second capacitor having a first side connected to the anode of said second diode and a second side opposite to said first side thereof, said second side of said second capacitor being connected to said second side of said first capacitor, at a second center tap.

2. The power converter of claim 1, wherein said first end of said first switch is connected to said positive input pole through a coil.

3. The power converter of claim 2, wherein said first end of said second switch is connected to said negative input pole through a coil.

4. The power converter of claim 1, wherein said first end of said second switch is connected to said negative input pole through a coil.

5. The power converter of claim 1, wherein said first and second center taps are each connected to ground.

6. The power converter of claim 1, further comprising:
a first inverter connected with said first capacitor; and
a second inverter connected with said second capacitor.

7. The power converter of claim 1, wherein said first end of said first capacitor is coupled to a first input of the inverter and said first end of said second capacitor is coupled to a second input of the inverter.

8. The power converter of claim 1, wherein the .d.c. voltage input is from a solar cell.

9. A method for controlling a power converter, the power converter having a d.c. voltage input which varies over time, has positive and negative inputs, and has a maximum voltage, the converter being capable of being connected to an electrical network having an inverter, the power converter including a level converter that comprises
a positive input pole for receiving a positive input from the d.c. voltage input and a negative input pole for receiving a negative input from the d.c. voltage input;
a first switch connected to said positive input pole of the d.c. voltage input at a first side of said first switch;
a first diode having an anode connected to said positive input pole and to said first side of said first switch;
a second switch connected to said negative input pole of the d.c. voltage input at a first side of said second switch, and having a second side connected to a second end of said first switch at a first center tap;
a second diode having a cathode connected to said negative input pole and to said first side of said second switch;
a first capacitor having a first side connected to the cathode of said first diode and a second side, opposite to said first side thereof; and
a second capacitor having a first side connected to the anode of said second diode and a second side opposite to said first side thereof, said second side of said second capacitor being connected to said second side of said first capacitor, at a second center tap;
wherein the method comprises:
controlling the level converter only when a voltage is applied to the d.c. voltage input which is less than a set-point intermediate circuit voltage V_{dcS}, so that a modulation factor of 1 results; and
charging said first and second capacitors with respectively half the value of the set-point intermediate circuit voltage V_{dcS}, by the steps of:
at an input d.c. voltage of less than half the value of the set-point intermediate circuit voltage V_{dcS}, controlling said first and second switches so that the activation times of said first and second switches overlap and alternate;
at an input d.c. voltage substantially equal to half the value of the set-point intermediate circuit voltage V_{dcS}, controlling said first and second switches so that the activation times of said first and second switches are each half a switching period long and alternate; and
at an input d.c. voltage of substantially greater than half the value of the set-point intermediate circuit voltage V_{dcS}, controlling said first and second switches so that the activation times of said first and second switches are less than half a switching period and alternate.
